(19) United States
(12) Patent Application Publication
(10) Pub. No.: US 2023/0058534 A1
(43) Pub. Date: Feb. 23, 2023

(54) VEHICLE BATTERY CONTROL DEVICE

(71) Applicant: MITSUBISHI JIDOSHA KOGYO KABUSHIKI KAISHA, Tokyo (JP)

(72) Inventors: Toshifumi MIZUI, Minato-ku, Tokyo (JP); Takeshi TOYODA, Minato-ku, Tokyo (JP); Yuichi KAMEI, Minato-ku, Tokyo (JP); Hiroshi TACHIBANA, Yokohama-shi, Kanagawa (JP)

(73) Assignee: MITSUBISHI JIDOSHA KOGYO KABUSHIKI KAISHA, Tokyo (JP)

(21) Appl. No.: 17/792,895

(22) PCT Filed: Jan. 15, 2021
(86) PCT No.: PCT/JP2021/001175

§ 371 Date: Jul. 14, 2022

(30) Foreign Application Priority Data
Jan. 15, 2020 (JP) 2020-004534

(51) Int. Cl. B60W 50/14; B60W 20/13

(52) U.S. Cl. CPC B60W 50/14; B60W 20/13; B60W 2050/146

(57) ABSTRACT

A battery control device includes: an input unit that selects and inputs a first battery operation mode that is one of a plurality of battery operation modes that control discharging from a battery to an electric motor and charging from a generator to the battery by an operation of an occupant of the vehicle; a selection status display unit that displays a mode indicator corresponding to each of the plurality of battery operation modes and displays a selection status in the input unit; a confirmation unit that confirms the first battery operation mode when a selected state of the first battery operation mode is maintained for a predetermined time after the first battery operation mode is selected in the input unit; and a battery operation control unit that controls the operation of the battery of the vehicle based on the first battery operation mode confirmed by the confirmation unit.

### TECHNICAL FIELD

The present invention relates to a battery control device for a vehicle including a battery, an electric motor, an engine, and a generator.

### BACKGROUND ART

In the related art, for example, a hybrid vehicle (HEV) having various driving modes is known in which an electric motor to which electric power of an in-vehicle battery, regenerative electric power, or electric power generated by a generator by driving an engine is supplied and an engine functioning as an internal combustion engine are used in combination.

### CITATION LIST

### Patent Literature

Patent Literature 1: JP-A-2011-093335

### SUMMARY OF INVENTION

### Technical Problem

It is desirable that an occupant (a driver or a fellow passenger) of a hybrid vehicle can select, by a simple operation, an operation mode of a battery related to electric vehicle (EV) driving in which the vehicle is caused to drive using only an electric motor to which electric power of the battery or regenerative electric power is supplied without driving the engine, and an operation mode of the battery related to hybrid vehicle (HEV) driving including series driving in which the vehicle is caused to drive using only the electric motor to which the electric power of the battery, the regenerative electric power, or the generated electric power is supplied while charging the battery with the electric power generated by the generator by driving the engine, and parallel driving in which the vehicle is caused to drive using a driving force of the electric motor to which the electric power is supplied from the battery or the like and the driving force of the engine in combination.

An object of the present invention is to provide a battery control device for a vehicle including a battery, an electric motor, an engine, and a generator, which can improve operability of an occupant.

### Solution to Problem

A battery control device is a device provided in a vehicle including a battery, an electric motor configured to generate a vehicle driving force by electric power of the battery, an engine, and a generator configured to be rotationally driven by a driving force of the engine to generate electric power. The battery control device includes an input unit configured to input a first battery operation mode, which is one of a plurality of battery operation modes that control discharging from a battery to an electric motor and charging from a generator to the battery, in accordance with an operation of an occupant of the vehicle; a selection status display unit configured to display a mode indicator corresponding to each of the plurality of battery operation modes and to display a selection status of the input unit; a confirmation unit configured to confirm the first battery operation mode in a case that the selected state of the first battery operation mode is maintained for a predetermined time after the first battery operation mode is selected by the input unit; and a battery operation control unit configured to control operation of the battery of the vehicle based on the first battery operation mode confirmed by the confirmation unit.

### Advantageous Effects of Invention

According to the present invention, it is possible to implement a battery control device for a vehicle including a battery, an electric motor, an engine, and a generator, which can improve operability of an occupant.

### BRIEF DESCRIPTION OF DRAWINGS

FIG. 1 is a schematic diagram showing a vehicle 10 provided with a battery control device 1.

FIG. 2 is a block diagram related to control and display of a plurality of operation modes of a battery 11.

FIG. 3 is a schematic diagram showing a mode display unit 100 and a battery mode switch 200 provided on a multi-display 21 of the vehicle 10.

FIG. 4 is a schematic diagram showing a state in which display of the mode display unit 100 of FIG. 3 is changed.

FIG. 5 is a schematic diagram showing a display example 1 of a constant display in a constant display unit 110.

FIG. 6 is a schematic diagram showing a display example 2 related to FIG. 5.

FIG. 7 is a schematic diagram showing a display example 3 related to FIG. 5.

FIG. 8 is a schematic diagram showing a display example 4 related to FIG. 5.

FIG. 9 is a schematic diagram showing the display example 1 of active display (selected state)/selectable display (selectable state) in a switching display 121 of a selection status display unit 120.

FIG. 10 is a schematic diagram showing a display example 2 related to FIG. 9.

FIG. 11 is a schematic diagram showing a display example 3 related to FIG. 9.

FIG. 12 is a schematic diagram showing a display example 4 related to FIG. 9.

FIG. 13 is a schematic diagram showing the display example 1 of active display (selected state)/selectable display (selectable state)/inactive display (unselectable state) in the switching display 121 of the selection status display unit 120.

FIG. 14 is a schematic diagram showing a display example 2 related to FIG. 13.

FIG. 15 is a schematic diagram showing a display example 3 related to FIG. 13.

FIG. 16 is a schematic diagram showing a display example 4 related to FIG. 13.

FIG. 17 is a schematic diagram showing a display example 5 related to FIG. 13.

FIG. 18 is a schematic diagram showing a display example 6 related to FIG. 13.

FIG. 19 is a schematic diagram showing the display example 1 of at least one of active display (selected state)/selectable display (selectable state)/inactive display (unselectable state) in the switching display 121 of the selection status display unit 120, and notification of an unavailability reason for the one display.

FIG. 20 is a schematic diagram showing a display example 2 related to FIG. 19.

FIG. 21 is a schematic diagram showing a display example 3 related to FIG. 19.

FIG. 22 is a schematic diagram showing a display example 4 related to FIG. 19.

FIG. 23 is a schematic diagram showing a display example 5 related to FIG. 19.

FIG. 24 is a schematic diagram showing a display example 6 related to FIG. 19.

FIG. 25 is a schematic diagram showing a display example 1 of a confirmed operation mode in a confirmation display 122 of the selection status display unit 120.

FIG. 26 is a schematic diagram showing a display example 2 related to FIG. 25.

FIG. 27 is a schematic diagram showing a display example 3 related to FIG. 25.

FIG. 28 is a schematic diagram showing a display example 4 related to FIG. 25.

FIG. 29 is a schematic diagram showing a display example 1 of a canceled operation mode in a determination display 123 of the selection status display unit 120.

FIG. 30 is a schematic diagram showing a display example 2 related to FIG. 29.

FIG. 31 is a schematic diagram showing a display example 3 related to FIG. 29.

FIG. 32 is a schematic diagram showing a display example 4 related to FIG. 29.

FIG. 33 is a schematic diagram showing a display example 5 related to FIG. 29.

FIG. 34 is a flowchart showing control related to switching and confirmation and determination of the operation mode of the battery.

FIG. 35 is a time chart showing a first example according to the control and the display of the battery control device 1.

FIG. 36 is a time chart showing a second example related to FIG. 35.

FIG. 37 is a time chart showing a third example of FIG. 35.

FIG. 38 is a time chart showing a fourth example of FIG. 35.

### DESCRIPTION OF EMBODIMENTS

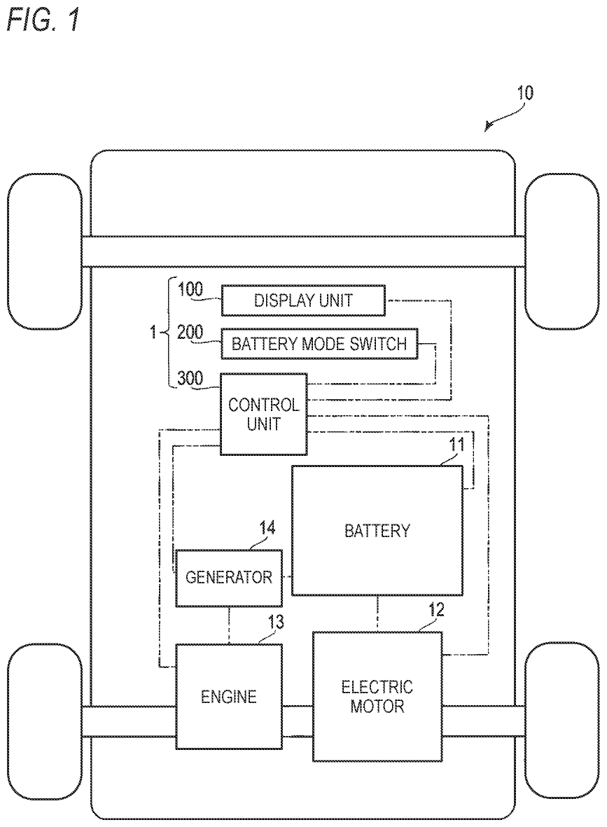

A configuration of the vehicle 10 provided with the battery control device 1 will be described with reference to FIG. 1.

FIG. 1 is a schematic diagram showing the vehicle 10 provided with the battery control device 1.

As shown in FIG. 1, the vehicle 10 includes the battery 11, an electric motor 12, an engine 13, and a generator 14. The battery 11 is implemented to be chargeable and dischargeable, and includes, for example, a lithium ion secondary battery. The battery 11 supplies (supplies and discharges) electric power to the electric motor 12 that drives the vehicle 10. The electric motor 12 is implemented to generate a vehicle driving force by the electric power of the battery 11. The engine 13 is an internal combustion engine to which fuel is supplied from a fuel tank and which generates the vehicle driving force. The generator 14 is implemented to be rotationally driven by a driving force of the engine 13 to generate the electric power.

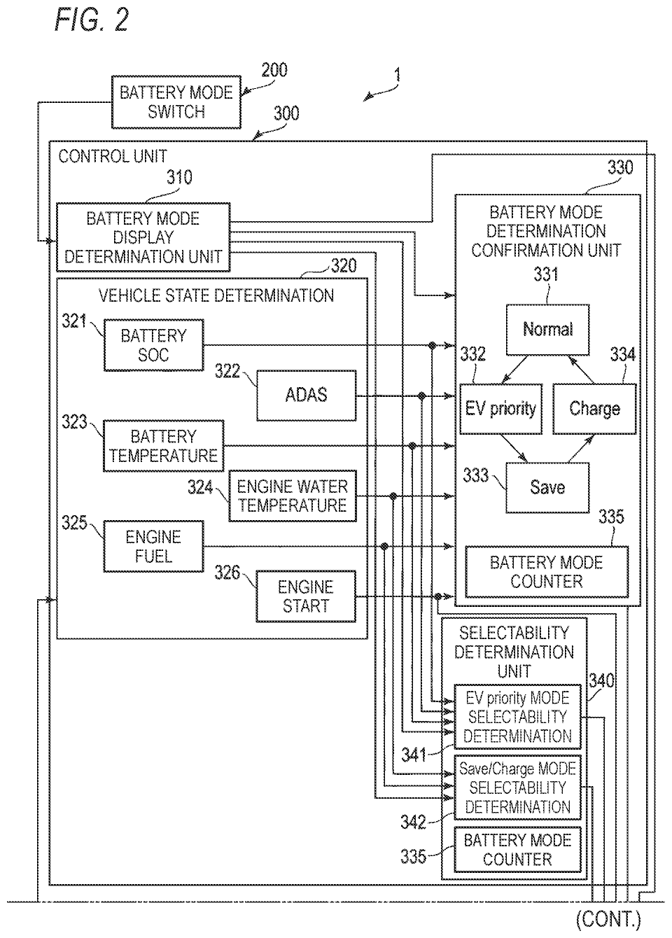

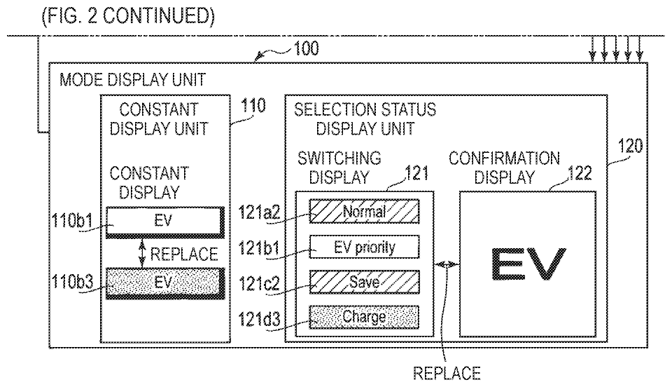

Here, the battery control device 1 provided in the vehicle 10 includes a mode display unit 100 that displays an operation mode of the battery 11, a battery mode switch 200 (input unit) implemented such that an occupant can select the operation mode of the battery 11, and a control unit 300 that controls the mode display unit 100 and the battery mode switch 200. Specific configurations of the mode display unit 100, the battery mode switch 200, and the control unit 300 of the battery control device 1 will be described later with reference to FIG. 2.

Configuration of control and display of the operation mode of the battery 11 will be described with reference to FIG. 2.

FIG. 2 is a block diagram related to control and display of a plurality of operation modes of the battery 11.

In a Normal mode, which is one operation mode of the battery 11, the control unit 300 automatically selects an optimum operation mode of the battery 11, for example, a default state at the time of shipment of the vehicle 10, according to a driving state of the vehicle 10, without the occupant selecting a special operation mode of the battery 11. In the Normal mode, when a state of charge (S0C) of the battery 11 decreases to a minimum predetermined value, the engine 13 is driven to generate the electric power by the generator 14, and the battery 11 is charged. The minimum predetermined value of the state of charge is set in consideration of the minimum electric power required for a hybrid vehicle to maintain normal driving. Specifically, the minimum predetermined value is, for example, a minimum state of charge required to start the engine 13. In order to start the engine 13, a starter is generally operated, whereas the generator 14 connected to the engine 13 may be operated by the electric power of the battery 11 to start the engine 13.

An EV priority mode, which is a first operation mode of the battery 11, restricts engine driving more than the Normal mode. In the EV priority mode, in principle, it is assumed that the engine of the vehicle 10 is not driven and only the electric power stored in the battery 11 or the regenerative electric power is used. In the EV priority mode, for example, even when the occupant depresses an accelerator to rapidly accelerate the vehicle 10, since the engine 13 is not started, the rapid acceleration of the vehicle 10 is prevented.

In a Save mode, which is a second operation mode of the battery 11, the current SOC of the battery 11 is set as a lower limit value, the engine 13 is driven to generate the electric power by the generator 14 so as to maintain the lower limit value, and the battery 11 is charged. Therefore, the lower limit value is set to a value between the minimum predetermined value and a maximum predetermined value described later. It is assumed that the Save mode is selected, for example, when the occupant is scheduled to use the electric power of the battery 11 to some extent at a driving destination of the vehicle 10, when the vehicle needs to drive using the electric motor 12 at a certain amount of electric power in the next driving, or the like, that is, when it is necessary to store a certain amount of electric power in the battery 11 at the driving destination of the vehicle 10. In the Save mode, the lower limit value may be set in advance between the minimum predetermined value and the maximum predetermined value and relatively higher than the minimum predetermined value (for example, SOC=50%) to maintain the lower limit value, instead of the current SOC of the battery 11. In the Save mode, the lower limit value may be set based on the current SOC of the battery 11, or may be set by the occupant to any value between the minimum predetermined value and the maximum predetermined value.

In a Charge mode, which is a third operation mode of the battery 11, the state of charge of the battery 11 is always maintained at a maximum predetermined value (for example, SOC=approximately 100% as an upper limit value). The maximum predetermined value is a maximum value of an SOC region in which the battery 11 can store electricity, and indicates, for example, an SOC in a fully charged state. In the Charge mode, when the SOC is less than the maximum predetermined value, in principle, the engine 13 is driven to generate the electric power by the generator 14, and the battery 11 is charged.

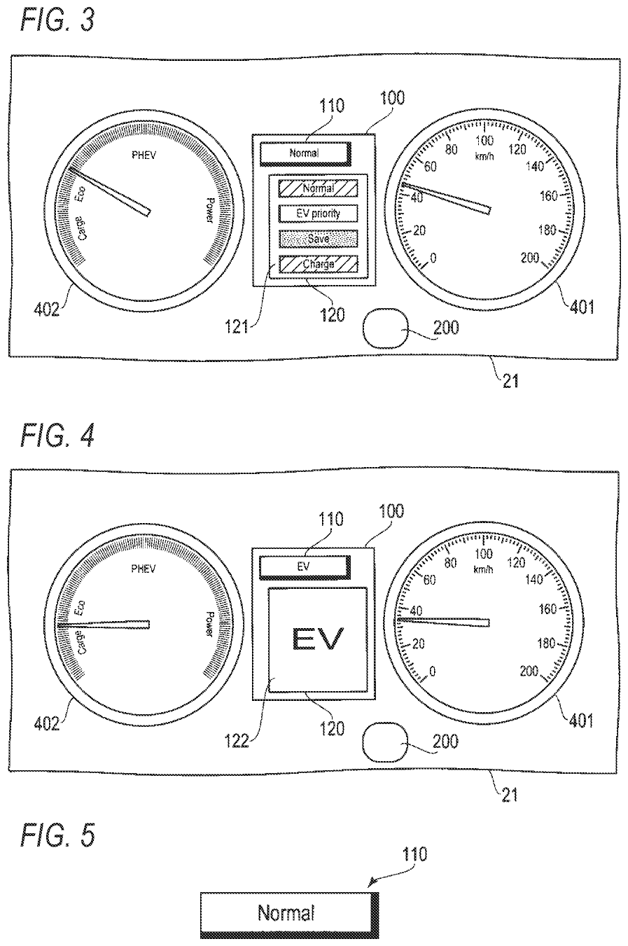

The mode display unit 100 includes the constant display unit 110 and the selection status display unit 120. The constant display unit 110 always displays a display mode corresponding to an indicator indicating the current operation mode of the battery 11 of the vehicle 10 without being operated by the occupant. On the other hand, in the selection status display unit 120, a selected state, a selectable state, and an unselectable state of the operation mode of the battery 11 are displayed, for example, side by side in an up-down direction. The selection status display unit 120 displays mode indicators respectively corresponding to the plurality of battery operation modes, and displays a selection status of the battery mode switch 200. As will be described later, the mode display unit 100 is provided in, for example, the multi-display 21 shown in FIG. 3.

In the constant display unit 110, an EV 110b1 in an active display mode (selected state) indicates that the current operation mode of the battery 11 is the EV priority mode. On the other hand, an EV 110b3 in a display mode in an inactive display (unselectable state) indicates that the EV priority mode cannot be selected as the current operation mode of the battery 11. On the constant display unit 110, the EV 110b1 and the EV 110b3 are displayed so as to be replaced with each other. That is, the EV 110b1 and the EV 110b3 are not simultaneously displayed on the constant display unit 110. Here, the EV 110b3 represents a state in which the EV priority mode is released and the engine 13 is started, when the occupant selects the EV priority mode as the operation mode, due to the state of charge of the battery 11 becoming less than a predetermined value, or for example, due to the occupant stepping on the accelerator in order to accelerate at a merging point, passing, or the like of an expressway. A specific example of the constant display in the constant display unit 110 will be described later with reference to FIGS. 5 to 8.

In the switching display 121 of the selection status display unit 120, the display modes corresponding to a plurality of operation modes of the battery 11 are displayed. The switching display 121 switches and displays a display form of the plurality of operation modes for one switch. In the switching display 121, for example, the operation modes of the Normal mode, the EV priority mode, the Save mode, and the Charge mode are arranged in this order from top to bottom.

Here, in the switching display 121, with the first Normal mode as an exception, in the second EV priority mode, the third Save mode, and the fourth Charge mode, the second EV priority mode arranged in an uppermost portion is a mode in which the engine 13 is most difficult to operate, and the fourth Charge mode arranged in a lowermost portion is a mode in which the engine 13 is most likely to operate. In the selection state display unit 120, the occupant arranges the EV priority mode, Save mode, and Charge mode in this order so that the more the mode is selected from the upper side to the lower side, the more easily the engine 13 is operated from the state in which the engine 13 is difficult to operate. That is, the second to fourth modes are arranged in the up-down direction in the order in which the engine 13 does not operate relatively. The switching display 121 is implemented such that the occupant operates the battery mode switch 200 to move a cursor corresponding to each operation mode from the top to the bottom one by one, and the cursor reaches the lowermost portion and then moves to the uppermost portion, thereby allowing the occupant to select any operation mode of the battery 11.

In the switching display 121, when the vehicle 10 is activated (ready on), unlike the configuration shown in FIG. 2, for example, the cursor of Normal 121a1 is selected as the default state. In this state, every time the occupant operates the battery mode switch 200, the cursor of the operation mode of the battery 11, which is selected in the order of EV priority 121b1, Save 121c1, and Charge 121d1 in the switching display 121, is moved down. A specific example of the switching display 121 will be described later with reference to FIGS. 9 to 24.

The confirmation display (confirmation notification unit) 122 of the selection status display unit 120 is displayed in place of the switching display 121 when the operation mode of the battery 11 selected by the occupant is confirmed, and displays the display mode of the operation mode of the battery 11 selected and confirmed by the occupant. That is, after the operation mode of a certain battery 11 is selected in the switching display 121, if the switching display 121 is maintained for several seconds without operating the battery mode switch 200, the display is switched to the confirmation display 122. As the confirmation display 122, for example, in FIG. 2, the EV (EV priority) mode is confirmed and displayed. A specific example of the confirmation display 122 will be described later with reference to FIGS. 25 to 28.

The battery mode switch (input unit) 200 receives selection of the occupant of the vehicle 10 on the switching display 121. In the battery mode switch 200, the occupant of the vehicle 10 selects and inputs a first battery operation mode, which is one of a plurality of battery operation modes for controlling discharging from the battery 11 to the electric motor 12 and charging from the generator 14 to the battery 11. The battery mode switch 200 is, for example, a selection button, and every time the battery mode switch 200 is operated (for example, pressed), the Normal mode, the EV priority mode, the Save mode, and the Charge mode of the battery 11 are sequentially selected. The battery mode switch 200 is implemented using, for example, a mechanical button. In addition, the battery mode switch 200 may be implemented as an operation lever, and an operation of pulling the lever may be set as a selection operation of each mode. Further, the battery mode switch 200 may be implemented as a paddle shift, and the operation of pulling the paddle or the operation of pulling the paddle away may be set as the selection operation of each mode. It is to be noted that the battery mode switch 200 may be implemented as a transparent touch panel provided so as to overlap a surface of the switching display 121, and for example, a touch operation may be used as the selection operation of each mode. In addition, the battery mode switch 200 may be implemented by an input device using a rotary body in which the operation modes sequentially appear or an input device using swiping. The battery mode switch 200 is connected to the control unit 300.

The control unit (battery operation control unit) 300 controls the operation of the battery of the vehicle 10 based on the first battery operation mode confirmed by a battery mode determination confirmation unit 330. The control unit 300 includes a battery mode display determination unit 310, a vehicle state determination unit 320, the battery mode determination confirmation unit (confirmation unit) 330, and a selectability determination unit 340. The control unit 300 is operated by a read only memory (ROM), an engine control unit (ECU), a random access memory (RAM), and the like.

When the occupant operates (for example, presses) the battery mode switch 200, the battery mode display determination unit 310 determines four types of cursor displays of the selected Normal 121a, EV priority 121b, Save 121c, and Charge 121d.

The vehicle state determination unit 320 includes an SOC determination unit 321, an ADAS determination unit 322, a battery temperature determination unit 323, an engine temperature determination unit 324, a fuel determination unit 325, and an engine start determination unit 326. The SOC determination unit 321 determines the SOC of the battery 11 mounted on the vehicle 10. The ADAS determination unit 322 determines a state of an advanced driver distance system (ADAS) of the vehicle 10. The battery temperature determination unit 323 determines a temperature of the battery 11 based on information from, for example, a battery temperature sensor (not shown) provided in the battery 11. The engine temperature determination unit 324 determines a cooling water temperature of the engine 13 based on information from, for example, an engine cooling water temperature sensor (not shown) that measures a water temperature of the cooling water circulating through the engine 13. The fuel determination unit 325 determines a remaining amount of fuel to be supplied to the engine 13 based on information from a fuel remaining amount detection sensor (not shown) provided in the fuel tank. The engine start determination unit 326 determines the start of the engine 13.

The battery mode determination confirmation unit (determination unit) 330 determines the first battery operation mode when the selected state of the first battery operation mode is maintained for a predetermined time after the first battery operation mode is selected by the battery mode switch 200. The battery mode determination confirmation unit 330 determines whether the operation mode of the battery 11 selected by the occupant is any one of Normal 331, EV priority 332, Save 333, and Charge 334, and transmits a result to the mode display unit 100 according to a predetermined time defined by a battery mode counter 335.

The selectability determination unit 340 includes a first selectability determination unit (determination unit) 341 and a second selectability determination unit (determination unit) 342. The first selectability determination unit 341 constantly determines whether the EV priority mode is unselectable based on information from the SOC determination unit 321, the ADAS determination unit 322, and the battery temperature determination unit 323 of the vehicle state determination unit 320, and transmits the EV priority mode to the mode display unit 100 when the selected state of the EV priority mode is maintained for the predetermined time. The second selectability determination unit 342 constantly determines whether the Save mode or the Charge mode is unselectable based on the information from the engine temperature determination unit 324 and the fuel determination unit 325 of the vehicle state determination unit 320, and transmits the modes to the mode display unit 100 when the selected state of the Save mode or the Charge mode is maintained for the predetermined time. The selectability determination unit 340 determines whether the operation mode of the battery 11 selected by the occupant is any one of Normal 331, EV priority 332, Save 333, and Charge 334, determines whether the selection is impossible according to the predetermined time defined by the battery mode counter 335, and transmits the result to the mode display unit 100.

The configuration of the mode display unit 100 provided in the multi-display 21 of the vehicle 10 will be described with reference to FIGS. 3 and 4.

FIG. 3 is a schematic diagram showing the mode display unit 100 and the battery mode switch 200 provided on the multi-display 21 of the vehicle 10. FIG. 4 is a schematic diagram showing a state in which display of the mode display unit 100 of FIG. 3 is changed. The multi-display 21 shown in FIG. 3 is provided, for example, on an instrument panel of the vehicle 10. The multi-display 21 is provided with indicators such as a speedometer 401 indicating a speed of the vehicle 10 and a power meter 402 indicating the driving force of the vehicle 10. Here, the mode display unit 100 is provided at a position that easily enters a field of view of the occupant, for example, between the speedometer 401 and the power meter 402. In the mode display unit 100, the constant display unit 110 and the selection status display unit 120 are provided, for example, side by side in the up-down direction. The mode display unit 100 may be provided in an indicator, an instrument indicator, a center panel, or the like of an instrument panel of the vehicle 10 instead of the multi-display 21. The battery mode switch 200 is provided, for example, below the mode display unit 100 and the speedometer 401. The battery mode switch 200 may be an operation switch, a press button, or an operation lever, and may be installed in a center console, an instrument panel in the vicinity of a steering wheel (handle), or a handle, instead of the multi-display 21.

In the mode display unit 100 of FIG. 3, for example, the Normal mode is displayed on the constant display unit 110 as the current operation mode of the vehicle 10. In the mode display unit 100 of FIG. 3, the switching display 121 for switching (changing) the current operation mode of the vehicle 10 is displayed in the selection status display unit 120. In the switching display 121, for example, the EV priority mode is displayed as active (selected state), the Normal mode and the Charge mode are displayed as selectable (selectable state), and the Save mode is displayed as inactive (unselectable state). That is, in this state, the current operation mode of the vehicle 10 is about to be changed from the Normal mode to the EV priority mode, but is not yet confirmed.

In the mode display unit 100 of FIG. 4, the EV (EV priority) mode is displayed on the constant display unit 110 as the current operation mode of the vehicle 10. That is, the operation mode in the state of FIG. 4 is replaced from the Normal mode to the EV priority mode as a result of the EV priority mode being displayed as active (selected state) in the switching display 121 shown in FIG. 3 being confirmed. In the selection status display unit 120, the switching display 121 is replaced with the confirmation display 122. In the confirmation display 122, the EV (EV priority) mode is displayed.

The constant display in the constant display unit 110 will be described with reference to FIGS. 5 to 8.

FIGS. 5 to 8 are schematic diagrams showing display examples 1 to 4 of the constant display in the constant display unit 110.

On the constant display unit 110 shown in FIG. 5, it is always displayed that the current operation mode of the battery 11 is Normal. That is, in order to notify the occupant that the current operation mode is Normal, for example, a display form including a character of Normal in black and a white background is always displayed on the constant display unit 110.

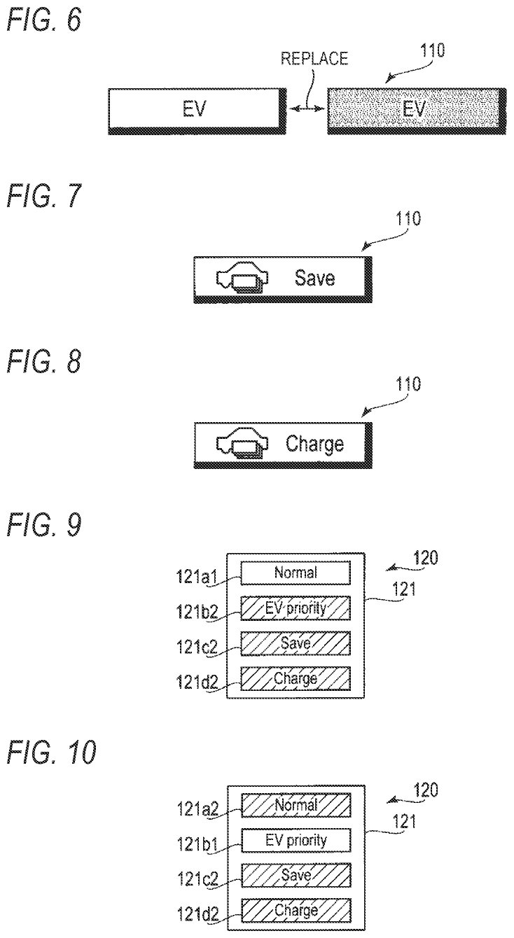

On the constant display unit 110 shown in FIG. 6, it is always displayed that the current operation mode of the battery 11 is the EV priority or the current operation mode of the battery 11 that is unselectable is the EV priority. That is, as shown on the left side of FIG. 6, for example, in order to notify the occupant that the current operation mode is the EV priority, a display form including, for example, the character of EV in black and the white background is always displayed on the constant display unit 110. Alternatively, as shown on the right side of FIG. 6, for example, in order to notify the occupant that the current operation mode that is unselectable is the EV priority, a display form including, for example, the character of EV in black and a dot display background is always displayed on the constant display unit 110. Only one of the display form on the left side in FIG. 6 and the display form on the right side in FIG. 6 is displayed so as to be replaced, and both are not displayed at the same time.

On the constant display unit 110 shown in FIG. 7, it is always displayed that the current operation mode of the battery 11 is Save. That is, in order to notify the occupant that the current operation mode is Save, for example, an illustration of an automobile on which a plurality of batteries are mounted and characters of Save are arranged on the left and right sides, and a display mode including the white background is always displayed on the constant display unit 110.

The constant display unit 110 shown in FIG. 8 always displays that the current operation mode of the battery 11 is Charge. That is, in order to notify the occupant that the current operation mode is Charge, for example, an illustration of an automobile on which a plurality of batteries are mounted and characters of Charge are arranged on the left and right sides, and a display mode including the white background is always displayed on the constant display unit 110.

The display of the active display (selected state)/selectable display (selectable state) in the switching display 121 of the selection status display unit 120 will be described with reference to FIGS. 9 to 12.

FIGS. 9 to 12 are schematic diagrams showing display examples 1 to 4 of the active display (selected state)/selectable display (selectable state) in the switching display 121 of the selection status display unit 120.

In the switching display 121 of the selection status display unit 120 shown in FIG. 9, “Normal” is displayed as active as one operation mode of the battery 11. That is, a first display mode (for example, the character of Normal in black and the white background) indicating that Normal is in the selected state is displayed in the Normal 121a1 as a certain indicator. In addition, as the selectable state, each indicator (for example, EV priority, Save, and Charge) is displayed in a second display mode (for example, characters of EV priority, Save, and Charge in black and a hatching display background) in the EV priority 121b2, the Save 121c2, and the Charge 121d2.

In the switching display 121 of the selection status display unit 120 shown in FIG. 10, EV priority is displayed as active as the first operation mode of the battery 11. That is, the first display mode (for example, the character of EV priority in black and the white background) indicating that EV priority is in the selected state is displayed as the first indicator in EV priority 121b1. In addition, as the selectable state, each indicator (for example, Normal, Save, and Charge) is displayed in the second display mode (for example, the characters of Normal, Save, and Charge in black and the hatching display background) in the Normal 121a2, the Save 121c2, and the Charge 121d2.

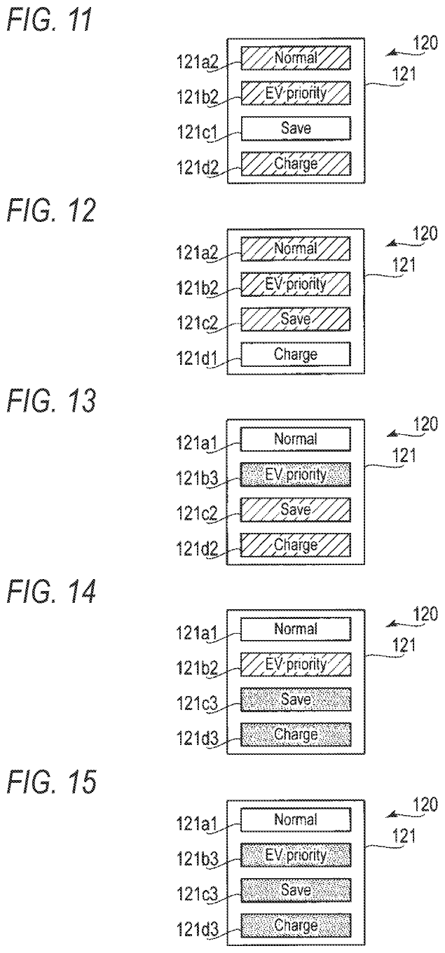

In the switching display 121 of the selection status display unit 120 shown in FIG. 11, Save is displayed as active as the second operation mode of the battery 11. That is, the first display mode (for example, the character of Save in black and the white background) indicating that Save is in the selected state is displayed in the Save 121c1 as a second indicator. In addition, as the selectable state, each indicator (for example, Normal, EV priority, and Charge) is displayed in the second display mode (for example, the characters of Normal, EV priority, and Charge in black and the hatching display background) in the Normal 121a2, the EV priority 121b2, and the Charge 121d2.

In the switching display 121 of the selection status display unit 120 shown in FIG. 12, Charge is displayed as active as the third operation mode of the battery 11. That is, the first display mode (for example, the character of Charge in black and the white background) indicating that Charge is in the selected state is displayed in the Charge 121d1 as a third indicator. In addition, as the selectable state, each indicator (for example, Normal, EV priority, Save) is displayed in the second display mode (for example, the characters of Normal, EV priority, Save in black and the hatching display background) in the Normal 121a2, the EV priority 121b2, and the Save 121c2.

A configuration in which the inactive display (unselectable state) is added to the active display (selected state)/selectable display (selectable state) in the switching display 121 of the selection status display unit 120 in FIG. 9 and the like will be described with reference to FIGS. 13 to 18.

FIGS. 13 to 18 are schematic diagrams showing display examples 1 to 6 of active display (selected state)/selectable display (selectable state)/inactive display (unselectable state) in the switching display 121 of the selection status display unit 120.

In the switching display 121 of the selection status display unit 120 shown in FIG. 13, the Normal 121a1 is displayed as the active display (selected state). Further, the Save 121c2 and the Charge 121d2 are displayed as selectable displays (selectable states). Here, the EV priority is displayed as inactive so as to indicate the unselectable state. That is, the third display mode (for example, the character of the EV priority in black and the dot display background) indicating that the EV priority which is the first indicator is in the unselectable state is displayed in the EV priority 121b3.

In the switching display 121 of the selection status display unit 120 shown in FIG. 14, the Normal 121a1 is displayed as the active display (selected state). Further, the EV priority 121b2 is displayed as the selectable display (selectable state). Here, Save and Charge are displayed as inactive so as to indicate the unselectable state. That is, the third display mode (for example, the characters of Save and Charge in black and the dot display background) indicating that Save and Charge, which are the second and third indicators, are in the unselectable state is displayed in Save 121c3 and Charge 121d3.

In the switching display 121 of the selection status display unit 120 shown in FIG. 15, the Normal 121a1 is displayed as the active display (selected state). In addition, the selectable display (selectable state) is not displayed. Here, EV priority, Save, and Charge are displayed as inactive so that the first, second, and third operation modes of the battery 11 indicate the unselectable state. That is, the third display mode (for example, the characters of EV priority, Save, and Charge in black and the dot display background) indicating that EV priority, Save, and Charge, which are the first, second, and third indicators, are in the unselectable state is displayed in the EV priority 121b3, the Save 121c3, and the Charge 121d3.

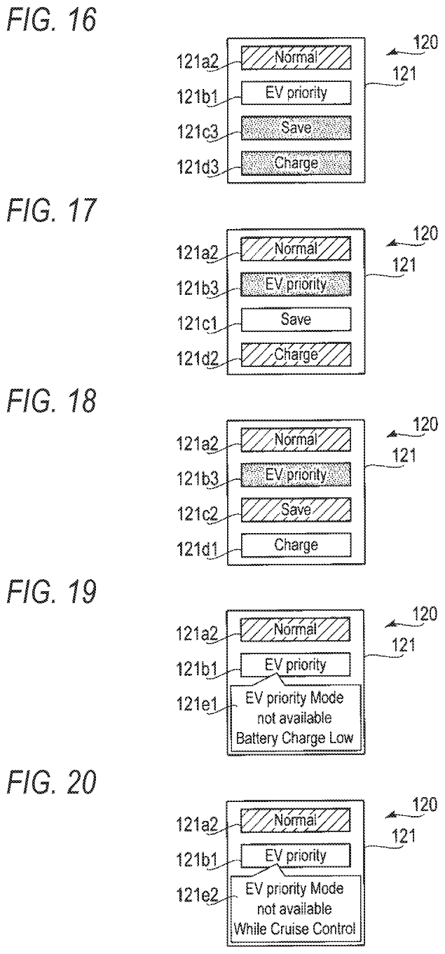

In the switching display 121 of the selection status display unit 120 shown in FIG. 16, the EV priority 121b1 is displayed as the active display (selected state). In addition, the Normal 121a2 is displayed as the selectable display (selectable state). Here, Save and Charge are displayed as inactive so as to indicate the unselectable state. That is, the third display mode (for example, the characters of Save and Charge in black and the dot display background) indicating that Save and Charge, which are the second and third indicators, are in the unselectable state is displayed in the Save 121c3 and the Charge 121d3.

In the switching display 121 of the selection status display unit 120 shown in FIG. 17, the Save 121c1 is displayed as the active display (selected state). In addition, the Normal 121a2 and the Charge 121d2 are displayed as the selectable displays (selectable states). Here, the EV priority is displayed as inactive so as to indicate the unselectable state. That is, the third display mode (for example, the character of the EV priority in black and the dot display background) indicating that the EV priority which is the first indicator is in the unselectable state is displayed in the EV priority 121b3.

In the switching display 121 of the selection status display unit 120 shown in FIG. 18, the Charge 121d1 is displayed as the active display (selected state). In addition, the Normal 121a2 and the Save 121c2 are displayed as the selectable displays (selectable states). Here, the EV priority is displayed as inactive so as to indicate the unselectable state. That is, the third display mode (for example, the character of the EV priority in black and the dot display background) indicating that the EV priority which is the first indicator is in the unselectable state is displayed in the EV priority 121b3.

In the switching display 121 of the selection status display unit 120 shown in FIGS. 9 to 18 described above, the four operation modes of Normal, EV priority, Save, and Charge are displayed in the same display mode except for characters for each of the active display (selected state), the selectable display (selectable state), and the inactive display (unselectable state). For example, in the active display (selected state), the display mode is implemented by characters of Normal, EV priority, Save, and Charge in black and the white background. Alternatively, the four operation modes of Normal, EV priority, Save, and Charge may be displayed in different display modes by changing colors and shades of characters and background or switching between lighting and blinking.

With reference to FIGS. 19 to 24, a description will be given of a configuration in which at least one of the active display (selected state), the selectable display (selectable state), and the inactive display (unselectable state) in the switching display 121 of the selection status display unit 120 in FIG. 13 and the like is added with the notification of the unavailability reason for the one display.

FIGS. 19 to 24 are schematic diagrams showing at least one of the active display (selected state), the selectable display (selectable state), and the inactive display (unselectable state) in the switching display 121 of the selection status display unit 120, and display examples 1 to 6 of the notification of the unavailability reason for the one display.

In the switching display 121 of the selection status display unit 120 shown in FIG. 19, the EV priority 121b1 is displayed as the active display (selected state). Here, a first blowout display unit 121e1 (unavailability reason notification unit) is displayed so as to indicate the EV priority 121b1. The first blowout display unit 121e1 is implemented by a so-called balloon, and the EV priority mode is displayed as being unable to be executed because the state of charge is low. The first blowout display unit 121e1 is displayed when the EV priority 121b1 is selected. The displayed first blowout display unit 121e1 overlaps, for example, other indicators (for example, Save and Charge) so as to hide other indicators (for example, Save and Charge) that are not selected. The Normal 121a2 is displayed as the selectable display (selectable state). The first blowout display unit 121e1 may be displayed outside a region range of the selection status display unit 120.

In the switching display 121 of the selection status display unit 120 shown in FIG. 20, a second blowout display unit 121e2 is displayed instead of the first blowout display unit 121e1 of FIG. 19. The second blowout display unit 121e2 displays that the EV priority mode cannot be executed because the vehicle 10 is under cruise control. In the cruise control, since the speed of the vehicle 10 and acceleration and deceleration of the vehicle 10 are controlled by constant vehicle speed control or other vehicle following control, the EV priority mode in which acceleration is relatively prevented is set to be unexecutable.

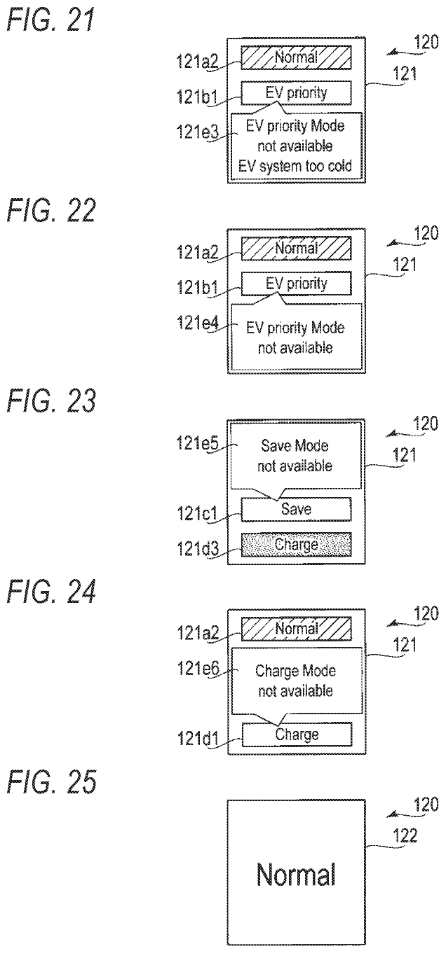

In the switching display 121 of the selection status display unit 120 shown in FIG. 21, a third blowout display unit 121e3 is displayed instead of the first blowout display unit 121e1 of FIG. 19. The third blowout display unit 121e3 displays that the EV priority mode cannot be executed due to the low temperature of the EV system.

In the switching display 121 of the selection status display unit 120 shown in FIG. 22, a fourth blowout display unit 121e4 is displayed instead of the first blowout display unit 121e1 of FIG. 19. The fourth blowout display unit 121e4 simply displays that the EV priority mode cannot be executed.

In the switching display 121 of the selection status display unit 120 shown in FIG. 23, the Save 121c1 is displayed as the active display (selected state). Here, a fifth blowout display unit 121e5 is displayed so as to point to Save 121c1. The fifth blowout display unit 121e5 simply displays that the Save mode cannot be executed. The fifth blowout display unit 121e5 is displayed when the Save 121c1 is selected. The fifth blowout display unit 121e5 is displayed so as to hide, for example, other indicators (Normal, EV priority) that are not selected. Further, as the inactive display (unselectable state), the Charge 121d3 is displayed. The fifth blowout display unit 121e5 may be displayed outside the region range of the selection status display unit 120.

In the switching display 121 of the selection status display unit 120 shown in FIG. 24, the Charge 121d1 is displayed as the active display (selected state). Here, a sixth blowout display unit 121e6 is displayed so as to point to the Charge 121d1. The sixth blowout display unit 121e6 simply displays that the Charge mode cannot be executed. The sixth blowout display unit 121e6 is displayed when the Charge 121d1 is selected. The sixth blowout display unit 121e6 to be displayed is displayed so as to hide, for example, other indicators (EV priority, Save) that are not selected. The Normal 121a2 is displayed as the selectable display (selectable state). The sixth blowout display unit 121e6 may be displayed outside the region range of the selection status display unit 120.

The display of the confirmed operation mode in the confirmation display 122 of the selection status display unit 120 will be described with reference to FIGS. 25 to 28.

FIGS. 25 to 28 are schematic diagrams showing display examples 1 to 4 of the confirmed operation mode in the confirmation display 122 of the selection status display unit 120.

In the confirmation display 122 of the selection status display unit 120 shown in FIG. 25, as a state in which the operation mode is confirmed to be Normal, a display mode represented by a character of Normal and a white background is displayed. For example, the confirmation display 122 shown in FIG. 25 is displayed so as to replace the switching display 121 after the Normal mode selected in the switching display 121 of FIGS. 9, 13, 14, and 15 is confirmed.

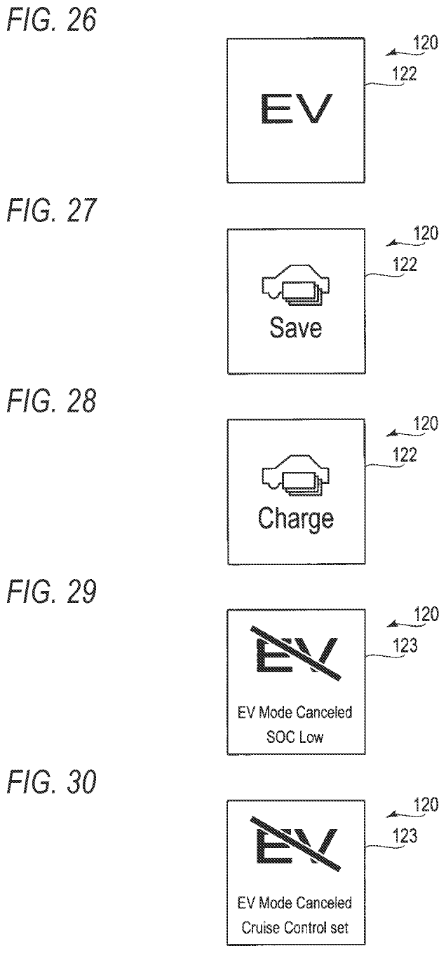

In the confirmation display 122 of the selection status display unit 120 shown in FIG. 26, as a state in which the operation mode is confirmed to be EV priority, a display mode represented by a character of EV and a white background is displayed. For example, the confirmation display 122 shown in FIG. 26 is displayed so as to replace the switching display 121 after the EV priority mode selected in the switching display 121 of FIGS. 10 and 16 is confirmed.

In the confirmation display 122 of the selection status display unit 120 shown in FIG. 27, as a state in which the operation mode is confirmed to be Save, a display mode in which an illustration of the automobile on which a plurality of batteries are mounted and a character of Save are displayed side by side in the up-down direction is displayed. For example, the confirmation display 122 shown in FIG. 27 is displayed so as to replace the switching display 121 after the Save mode selected in the switching display 121 of FIGS. 11 and 17 is confirmed.

In the confirmation display 122 of the selection status display unit 120 shown in FIG. 28, as a state in which the operation mode is confirmed to be Charge, a display mode in which an illustration of the automobile on which the plurality of batteries are mounted and a character of Charge are arranged in the up-down direction is displayed. For example, the confirmation display 122 shown in FIG. 28 is displayed so as to replace the switching display 121 after the Charge mode selected in the switching display 121 of FIGS. 12 and 18 is confirmed.

The display of a canceled operation mode in the determination display 123 of the selection status display unit 120 will be described with reference to FIGS. 29 to 33.

FIGS. 29 to 33 are schematic diagrams showing display examples 1 to 5 of the canceled operation mode in the determination display 123 of the selection status display unit

In the determination display 123 of the selection status display unit 120 shown in FIG. 29, it is displayed that the operation mode determined to be cancelled is the EV priority mode. In the determination display 123 of FIG. 29, a display mode is displayed in which a character of EV drawn with a diagonal line and a short sentence disclosing that the reason for cancellation is low in the SOC are arranged in the up-down direction. In the determination display 123, the character of the EV drawn with the diagonal line is displayed, for example, larger and higher than the short sentence for which the reason for cancellation is described. For example, the determination display 123 shown in FIG. 29 is displayed so as to replace the switching display 121 after the cancellation of the EV priority mode selected in the switching display 121 of FIG. 19 is determined.

The determination display 123 of the selection status display unit 120 shown in FIG. 30 is different from the determination display 123 shown in FIG. 29 only in the short sentence disclosing the reason why the operation mode is cancelled. In the determination display 123 of FIG. 30, the short sentence disclosing that the cruise control of the vehicle 10 is performed is displayed as the reason for the cancellation. For example, the determination display 123 shown in FIG. 30 is displayed so as to replace the switching display 121 after the cancellation of the EV priority mode selected in the switching display 121 of FIG. 20 is determined.

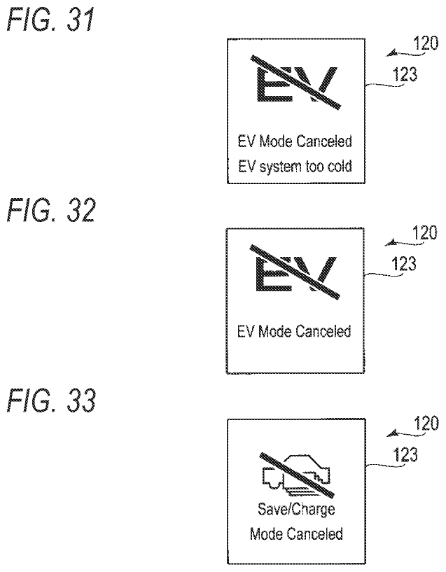

The determination display 123 of the selection status display unit 120 shown in FIG. 31 is different from the determination display 123 shown in FIG. 29 only in the short sentence disclosing the reason why the operation mode is cancelled. In the determination display 123 of FIG. 31, the short sentence disclosing that the EV system is at the low temperature is displayed as the reason for cancellation. For example, the determination display 123 shown in FIG. 31 is displayed after the cancellation of the EV priority mode selected in the switching display 121 of FIG. 21 is determined.

The determination display 123 of the selection status display unit 120 shown in FIG. 32 is different from the determination display 123 shown in FIG. 29 only in the short sentence disclosing the reason why the operation mode is cancelled. In the determination display 123 of FIG. 32, the short sentence that simply discloses that the EV priority mode is cancelled is displayed. For example, the determination display 123 shown in FIG. 32 is displayed so as to replace the switching display 121 after the cancellation of the EV priority mode selected in the switching display 121 of FIG. 22 is determined.

In the determination display 123 of the selection status display unit 120 shown in FIG. 33, it is displayed that the operation mode determined to be cancelled is the Save mode or the Charge mode. In the determination display 123 of FIG. 33, as a state in which the cancellation of the Save mode or the Charge mode is determined, a display mode is displayed in which an illustration of the automobile on which the plurality of batteries are mounted with a diagonal line drawn and the short sentence disclosing that the Save mode or the Charge mode is cancelled are arranged in the up-down direction. For example, after the cancellation of the Save mode selected in the switching display 121 of FIG. 23 or the Charge mode selected in the switching display 121 of FIG. 24 is determined, the determination display 123 shown in FIG. 33 is displayed so as to replace the switching display 121.

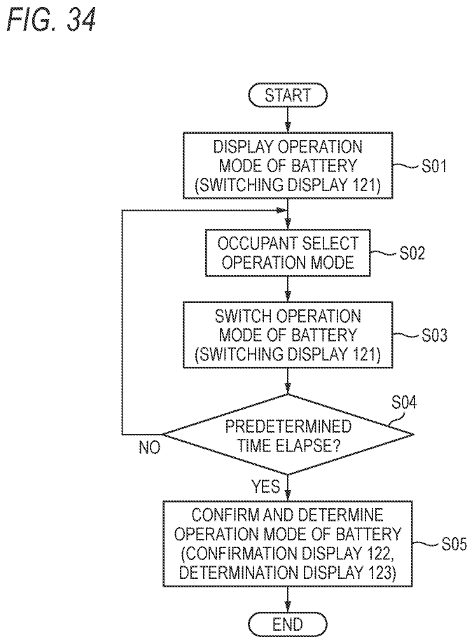

The control related to the switching and the confirmation and determination of the operation mode of the battery 11 and will be described with reference to FIG. 34. FIG. 34 is a flowchart showing the control related to the switching and the confirmation and determination of the operation mode of the battery 11.

First, in step 1 (S01), a display mode corresponding to each of the operation modes of, for example, the Normal mode, the EV priority mode, the Save mode, and the Charge mode is displayed on the switching display 121 of the selection status display unit 120. Next, in step 2 (S02), the occupant operates the battery mode switch 200 to select any operation mode from among the plurality of operation modes displayed on the switching display 121. Next, in step 3 (S03), in synchronization with step 2 (S02), the any operation mode selected by the occupant is displayed on the switching display 121 in a different display mode. Next, in step 4 (S04), when a predetermined time elapses after the occupant operates the battery mode switch 200 (Yes), the processing proceeds to step 5 (S05), the operation mode selected immediately before by the occupant is confirmed or determined, and the display mode corresponding to the confirmed and determined operation mode is displayed on the confirmation display 122 or the determination display 123. On the other hand, in step 4 (S04), when an interval of a time during which the occupant operates the battery mode switch 200 is shorter than the predetermined time, that is, when the occupant operates the battery mode switch 200 again before the predetermined time elapses after the occupant operates the battery mode switch 200 (No), the processing returns to step 2 (S02).

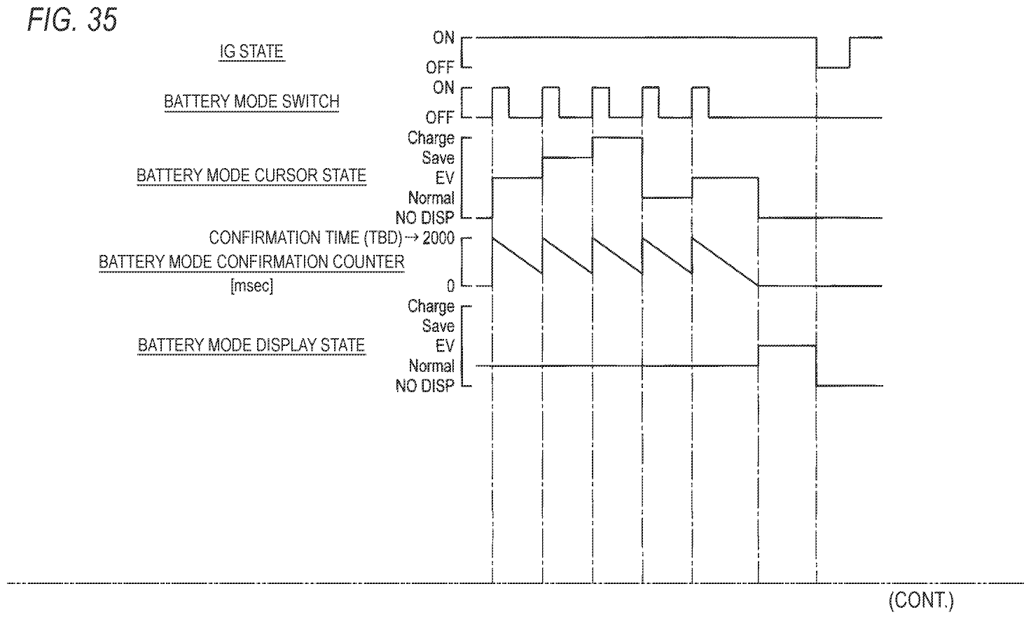

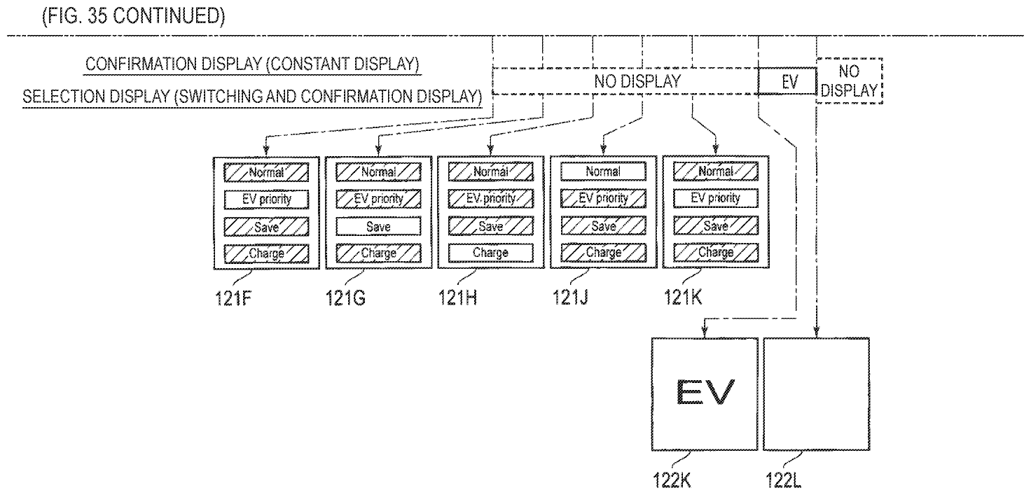

A first example related to control and display of the battery control device 1 will be described with reference to FIG. 35.

FIG. 35 is a time chart showing the first example related to the control and display of the battery control device 1.

In the first example shown in FIG. 35, an example is shown in which the occupant repeatedly operates the battery mode switch 200 to select any operation mode, and then the operation mode is confirmed. In particular, in the first example, an example is shown in which the occupant once passes the EV priority mode displayed by operating the battery mode switch 200, and then selects the EV priority mode displayed by operating the battery mode switch 200 a plurality of times again.

When the occupant operates the battery mode switch 200, a battery mode cursor state transitions to EV (EV priority), Save, Charge, Normal, and EV. That is, the operation mode of the battery 11 for which the cursor is selected in the selection status display unit 120 is switched from the Normal mode, which is the default display, to the EV priority mode shown in a switching display 121F, the Save mode shown in a switching display 121G, the Charge mode shown in a switching display 121H, the Normal mode shown in a switch display 121J, and the EV priority mode shown in a switching display 121K in this order. This is because the interval at which the occupant operates the battery mode switch 200 is shorter than 2 seconds, which is a predetermined time 2000 [msec] set by the battery mode counter 335. The predetermined time is set to, for example, 2 seconds, but may be shorter or longer than 2 seconds. Every time the switching display 121 is switched, the battery mode counter 335 is reset.

In a state of the EV priority mode shown in the switching display 121K, when the occupant stops the operation of the battery mode switch 200 and 2 seconds elapse, the switching display 121K is switched to the confirmation display 122K. In the confirmation display 122K, EV (EV priority) is displayed. The confirmation display 122K is switched to the confirmation display 122L in a non-display state after a predetermined time elapses. In the constant display unit 110, the display mode of EV (EV priority) is displayed during a period from when the confirmation display 122K is displayed to when an IG power supply is turned off. When the IG power supply is turned off, the display mode related to the operation mode of the battery 11 displayed in the switching display 121 and a confirmation display region is reset.

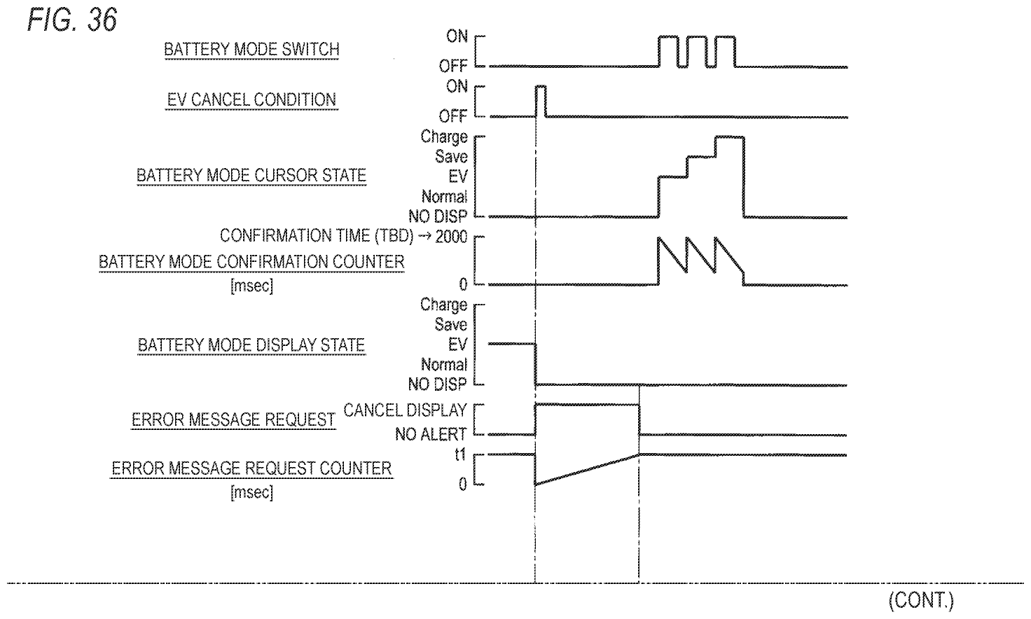

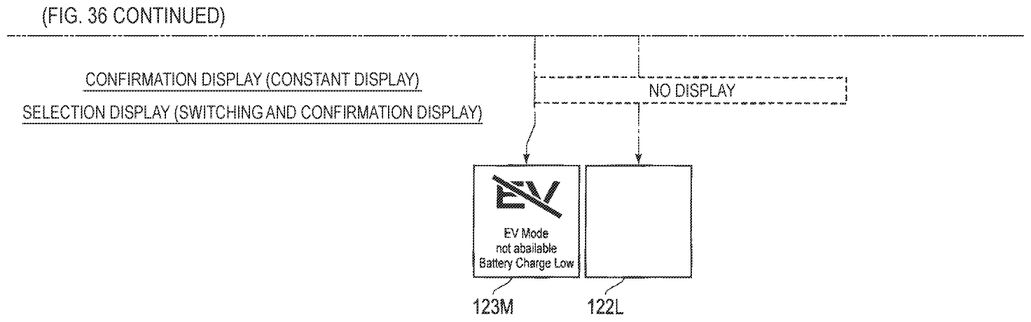

A second example related to the control and display of the battery control device 1 will be described with reference to FIG. 36.

FIG. 36 is a time chart showing the second example of the control and display of the battery control device 1.

In the second example shown in FIG. 36, after a cancellation condition of the operation mode of the EV priority mode is satisfied during the operation mode of the EV priority mode, the operation mode automatically transitions to the operation mode of the Normal mode while displaying a fact on a determination display 123M.

For example, when the state of charge of the battery 11 is less than a predetermined value, the EV priority mode is cancelled to start the engine 13 and charge the battery 11, and transitions to the Normal mode. In addition, the EV priority mode is cancelled in order to start the engine 13 and secure the driving force when the occupant depresses the accelerator to rapidly accelerate the vehicle, and the EV priority mode transitions to the Normal mode. When the cancellation condition is satisfied during specific mode control, the mode display unit 100 receives a cancellation display request for the mode. A mode display state of the mode display unit 100 is NO DISP (non-display). That is, after the determination display 123M indicates that the state of charge of the battery 11 is low, the confirmation display 122L is in the non-display state.

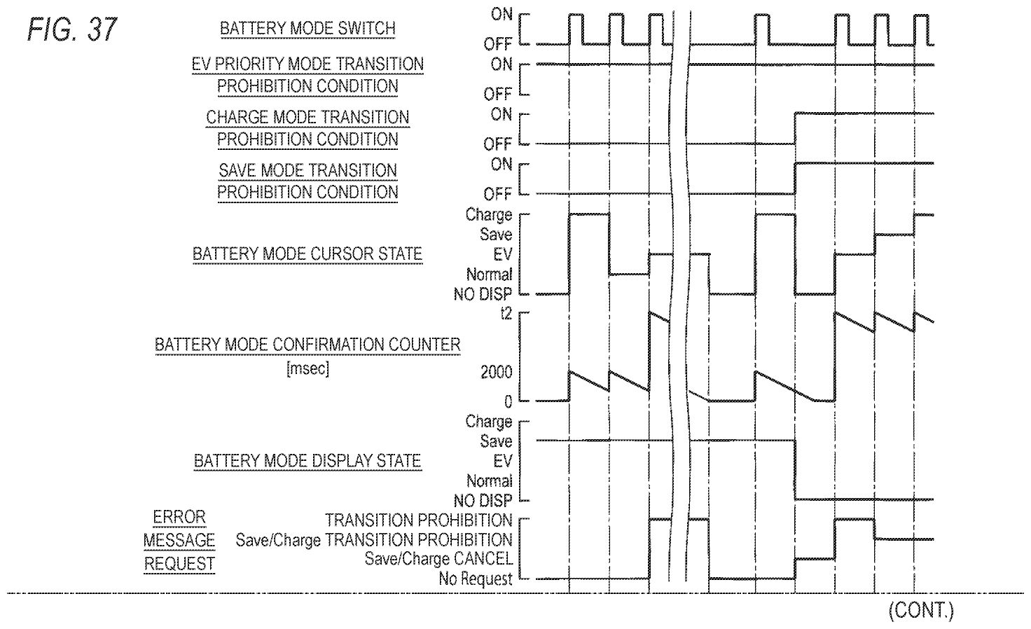

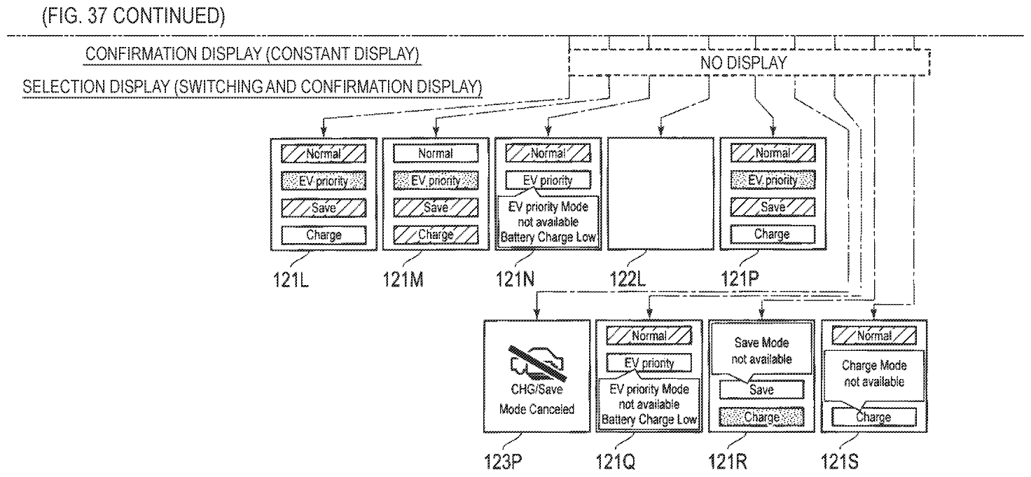

A third example related to the control and display of the battery control device 1 will be described with reference to FIG. 37.

FIG. 37 is a time chart showing the third example related to control and display of the battery control device 1.

In the third example shown in FIG. 37, in the switching display 121, the display of the operation mode of the battery 11 that is unselectable is grayed out (displayed in the dot display background in the drawing) to notify the occupant.

In the selection status display unit 120, the switching display 121L in which the EV priority mode is grayed out and the Charge mode is selected is switched to the switching display 121M in which the Normal mode is selected by the occupant operating the battery mode switch 200 once. When the occupant operates the battery mode switch 200 once from the state of the switching display 121M, the switching display 121N is switched to the switching display 121N in which the EV priority mode is selected. In the switching display 121N, since the state of charge of the battery 11 is low in the balloon indicating the EV priority mode, the mode is displayed as unexecutable. Thereafter, the switching display 121N is switched to the confirmation display 122L in the non-display state. Here, in the third example of the embodiment, the battery mode selected first in the vehicle 10 is the Save mode. In this state, when the occupant presses the battery mode switch 200 a plurality of times and the selection of the EV priority mode is rejected, the Save mode selected first is maintained, and after the confirmation display 122L in non-display state, when the occupant presses the battery mode switch 200 once, a switching display 121P of the Charge mode is displayed. Of course, when the occupant presses the battery mode switch 200 a plurality of times and the selection of the EV priority mode is rejected, the mode may be returned to the Normal mode. Thereafter, the operation mode of the battery 11 is switched to the switching display 121P in which the Charge mode is selected by the selection of the occupant. When a charge mode transition prohibition condition is satisfied, the switching display 121P is switched to the determination display 123P indicating that “CHG (Charge)” and the Save mode are cancelled and thus cannot be executed. Here, when the Save mode is cancelled, the mode is automatically transitioned to the Normal mode. In the third example of the embodiment, from the viewpoint of usability, a cancellation reason for which the occupant is desired to be notified with higher priority is displayed without simultaneously displaying cancellation display of the Save mode and the confirmation display 122 of the Normal mode. However, in the third example of the embodiment, the mode is changed to NO DISP without determining whether the Save mode is canceled and automatically transitioned to the Normal mode or the mode is transitioned to the Normal mode according to an intention of the occupant. Of course, since the occupant recognizes that the normal mode is selected even in the case of NO DISP, when the occupant presses the battery mode switch 200 in this state, the Normal mode is skipped and the EV Priority is transitioned. Thereafter, the display is switched in the order of the switching display 121Q indicating that the selected EV priority mode is unexecutable because the state of charge of the battery 11 is low, the switching display 121R indicating that the selected Save mode is unexecutable and the Charge mode is grayed out, and the switching display 121S indicating that the selected Charge mode is unexecutable.

In the third example, the operation mode of the battery 11 that is grayed out as described above indicates that the operation mode that is unselectable changes as needed in accordance with a change in the state of the vehicle 10 during driving. Further, after the operation mode of the selectable battery 11 is selected, the operation mode may become unexecutable. As described above, in the third example, the operation mode of the battery 11 that becomes unexecutable before the selection is confirmed and the operation mode of the battery 11 that becomes unexecutable after the selection is confirmed are displayed on the mode display unit 100 at any time to notify the occupant of the operation mode.

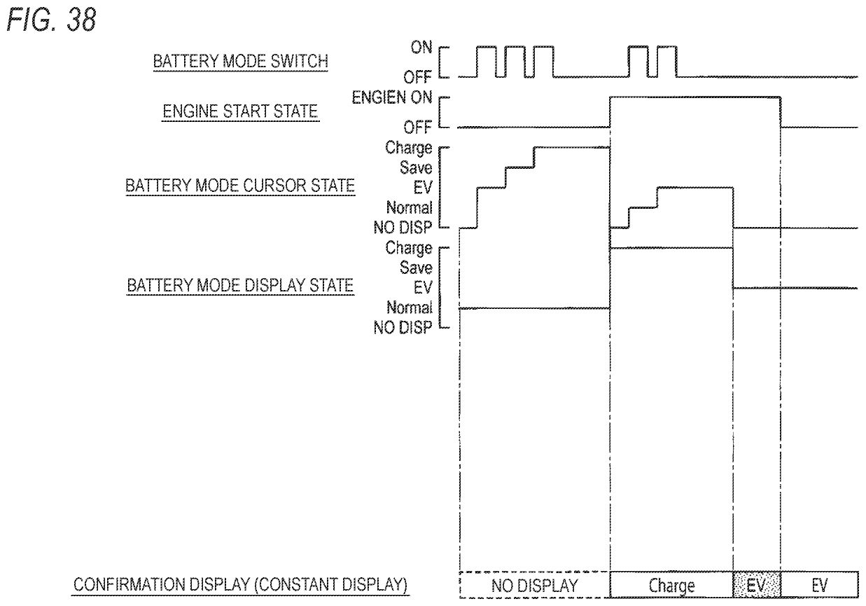

A fourth example related to control and display of the battery control device 1 will be described with reference to FIG. 38. FIG. 38 is a time chart showing the fourth example related to the control and display of the battery control device 1.

In the fourth example of the control, an example is shown in which the display mode of the constant display unit 110 is always grayed out when the engine is started in the EV priority mode.

When the temperature of the battery is equal to or higher than the predetermined value, when the state of charge of the battery is lower than the predetermined value, or when the driver depresses the accelerator to rapidly accelerate the vehicle, the engine is forcibly started regardless of the operation mode of the battery selected by the driver. In this case, “EV”, which is a grayed-out display, is displayed on the constant display unit 110. Here, when a battery mode display state and the constant display indicate the Charge mode, the control state of the vehicle 10 is the Charge mode. On the other hand, the battery mode cursor state indicates the EV priority mode that the occupant is about to select from now on.

Operations and effects based on the configuration of the battery control device 1 will be described.

The battery control device 1 includes the battery mode switch (input unit) 200, the selection state display unit 120, the battery mode determination confirmation unit (confirmation unit) 330, and the control unit (battery operation control unit) 300. According to such a configuration, the occupant can confirm the selection state of the battery operation mode by viewing the selection state display unit 120 while operating the battery mode switch 200. Therefore, the battery control device 1 can improve the operability of the occupant in the vehicle 10 including the battery 11, the electric motor 12, the engine 13, and the generator 14.

According to the battery control device 1 in the embodiment, as shown in FIG. 2, the selection status display unit 120 displays mode indicators respectively corresponding to the plurality of battery operation modes (for example, Normal, EV priority, Save, and Charge) side by side. The battery mode switch 200 sequentially selects the plurality of battery operation modes in accordance with the arrangement order of the mode indicators of the selection status display unit 120. According to such a configuration, the occupant can select any battery operation mode by using the battery mode switch 200 which is one switch while simultaneously viewing the plurality of arranged battery operation modes, and can implement a simpler switch layout with respect to other mechanical operation modes in which a plurality of switches corresponding to the plurality of battery operation modes are provided. When the arrangement order is arranged in the order of the difficulty or ease of the engine operation in the battery operation mode, or a target value of the state of charge of the battery controlled by the engine operation, the battery operation mode can be intuitively identified, and the determination of the selection can be made more easily.

As shown in FIG. 2, the battery control device 1 in the embodiment includes the selectability determination unit 340 that determines whether each of the plurality of battery operation modes is selectable according to the status of the vehicle 10. The selection status display unit 120 displays the mode indicators respectively corresponding to the plurality of battery operation modes side by side, and displays the battery operation mode that is determined to be selectable by the selectability determination unit 340 and is in the selectable display (selectable state) in a display mode different from the battery operation mode that is in the active display (selected state). The mode display unit 100 displays one mode indicator selected by the battery mode switch 200 in a display mode distinguishable from other mode indicators. According to such a configuration, the occupant can easily visually recognize whether the battery operation mode is the active display (selected state) or the selectable display (selectable state).

According to the battery control device 1 in the embodiment, for example, as shown in FIG. 13, the selection status display unit 120 displays the EV priority 121b3 determined to be unselectable by the selectability determination unit 340 in a display mode different from the first battery operation mode and a second battery operation mode, that is, in the inactive display (unselectable state). The mode display unit 100 displays the battery operation mode determined to be unselectable by the selectability determination unit 340 in a different display mode that can be distinguished from other mode indicators. According to such a configuration, the occupant can easily visually recognize the unselectable battery operation mode.

According to the battery control device 1 in the embodiment, for example, as shown in FIG. 19, the battery control device 1 includes the first blowout display unit (unavailability reason notification unit) 121e1 that notifies the unavailability reason of the EV priority mode determined to be unselectable by the selectability determination unit 340. The mode display unit 100 displays the unavailability reason for notifying the unavailability reason of the battery operation mode determined to be unselectable by the selectability determination unit 340. According to such a configuration, the occupant can easily know the reason why the battery operation mode is unselectable. The unavailability reason notification unit may display the unavailability reason in a region other than the switching display 121. The configuration of the unavailability reason notification unit is not limited to visual display using the blowout display unit 121e, and may be, for example, a sound notification.

According to the battery control device 1 in the embodiment, for example, as shown in FIG. 19, the first blowout display unit 121e1 is displayed so as to overlap the selection status display unit 120, and hides a part of the mode indicators displayed side by side in the selection status display unit 120. The mode display unit 100 displays the unavailability reason in an overlapping manner so as to hide a part of the mode indicator. That is, the first blowout display unit 121e1 is displayed in the overlapping manner from above so as to hide the indicator of the operation mode of the battery 11 that is not indicated. According to such a configuration, for example, a display space of the selection status display unit 120 can be implemented to be small. On the other hand, for example, when there is a margin in the display space of the selection status display unit 120, the blowout display unit may display the indicator of the operation mode of the battery 11 that is not pointed out so as not to be covered at all, or may display the indicator so as to be partially hidden. In addition, since the blowout display unit indicates the unexecutable battery operation mode, it is possible to reduce the display space of the selection status display unit 120 by simply displaying that the battery operation mode cannot be executed and omitting the display regarding which battery operation mode cannot be executed.

For example, as shown in FIG. 26, the battery control device 1 in the embodiment includes a confirmation display (confirmation notification unit) 122 that notifies the occupant of the vehicle 10 of the EV priority mode corresponding to the confirmed first battery operation mode. According to such a configuration, the occupant can easily know the confirmed battery operation mode. The configuration of the confirmation notification unit is not limited to the visual display using the confirmation display 122, and may be, for example, a sound notification.

As shown in FIG. 2, the battery control device 1 in the embodiment includes the battery mode selectability determination units (determination units) 341 and 342 that determine a third battery operation mode after the battery operation mode is selected by the battery mode switch 200, and a determination notification unit that notifies the occupant of the vehicle 10 of the determined third battery operation mode. According to such a configuration, the occupant can sufficiently recognize that the battery operation mode selected by the occupant is unselectable. The configuration of the determination notification unit is not limited to the visual display similar to the confirmation display 122, and may be, for example, a sound notification.

According to the battery control device 1 in the embodiment, as shown in FIG. 2, the constant display unit 110 that constantly displays the mode indicator corresponding to the confirmed first battery operation mode during the period of the first battery operation mode is provided. The mode display unit 100 constantly displays the mode indicator determined after being selected by the battery mode switch 200 during a confirmed battery operation period. According to such a configuration, the occupant can confirm the current battery operation mode at any time. Instead of the constant display unit 110, the confirmation display 122 of the selection status display unit 120 may be implemented to be constantly displayed until the occupant operates the battery mode switch 200 next time.

According to the battery control device 1 in the embodiment, as shown in FIG. 3, the constant display unit 110 is provided at a position different from that of the selection status display unit 120. The mode display unit 100 displays the mode indicator at a position different from the arrangement of the mode indicators. According to such a configuration, the occupant can easily know the confirmed current battery operation mode without depending on the selection state display unit 120 to which a large amount of information is notified.

According to the battery control device 1 in the embodiment, the mode display unit 100 displays the mode indicators side by side in the ascending order of a drive permission range of the engine 13. For example, EV priority, Save, and Charge are arranged in this order. According to such a configuration, it is possible to restrict the driving of the engine 13 and to cause the vehicle 10 to drive using the electric power or the regenerative electric power stored in the battery 11. By arranging and displaying each of the mode indicators in the ascending order of the drive permission range, for example, even when the occupant has an intention to select the third battery operation mode but the occupant selects the EV priority mode corresponding to the first battery operation mode without intending to sequentially select the battery operation mode, it is possible to make it difficult for the unintended start of the engine 13 to occur.

According to the battery control device 1 in the embodiment, the drive permission range of the engine 13 is determined based on the state of charge of the battery 11. According to such a configuration, it is possible to stably start the engine 13 using the electric power of the battery 11 regardless of the battery operation mode.

In carrying out the present invention, the above-described embodiment is an example, and the present invention can be carried out by variously changing specific aspects. The present application is based on the Japanese patent application (Japanese Patent Application No. 2020-004534) filed on Jan. 15, 2020, and the contents thereof are incorporated herein as reference.

### INDUSTRIAL APPLICABILITY

The battery control device according to the present invention is useful for improving the operability by the occupant of the vehicle including the battery, the electric motor, the engine, and the generator.

### REFERENCE SIGNS LIST

1 battery control device
10 vehicle
11 battery
12 electric motor
13 engine
14 generator
21 multi-display
100 display unit
110 constant display unit
120 selection status display unit
121 switching display
121a, 121a1, 121a2 Normal
121b, 121b1, 121b2, 121b3 EV priority
121c, 121c1, 121c2, 121c3 Save
121d, 121d1, 121d2, 121d3 Charge
122 confirmation display
123 determination display
200 battery mode switch (input unit)
300 control unit
310 battery mode display determination unit
320 vehicle state determination unit
330 battery mode determination confirmation unit
335 battery mode counter
340 selectability determination unit
341 first selectability determination unit
342 second selectability determination unit

1-10. (canceled)

11. A battery control device for a vehicle including a battery, an electric motor configured to generate a vehicle driving force by electric power of the battery, an engine, and a generator configured to be rotationally driven by a driving force of the engine to generate electric power,
the battery control device comprising:
an input unit configured to select and input a first battery operation mode, which is one of a plurality of battery operation modes that control discharging from the battery to the electric motor and charging from the generator to the battery, in accordance with an operation of an occupant of the vehicle;
a selection status display unit configured to display a mode indicator corresponding to each of the plurality of battery operation modes and to display a selection status in the input unit;
a confirmation unit configured to confirm the first battery operation mode in a case that a selected state of the first battery operation mode is maintained for a predetermined time after the first battery operation mode is selected by the input unit;
a battery operation control unit configured to control an operation of the battery of the vehicle based on the first battery operation mode confirmed by the confirmation unit; and
a selectability determination unit configured to determine whether each of the plurality of battery operation modes is selectable based on a status of the vehicle,
wherein the selection status display unit is configured to display the mode indicators respectively corresponding to the plurality of battery operation modes side by side;
wherein the selection status display unit is configured to display a second battery operation mode determined to be selectable by the selectability determination unit in a display mode different from a display mode of the first battery operation mode;
wherein the selection status display unit is configured to display a third battery operation mode determined to be unselectable by the selectability determination unit in a display mode different from the display modes of the first battery operation mode and the second battery operation mode;
wherein the input unit sequentially selects the plurality of battery operation modes in accordance with an arrangement order of the mode indicators of the selection status display unit; and
wherein the selection status display unit is configured to display the first battery operation mode, the second battery operation mode, and the third battery operation mode simultaneously in three kinds of display modes which are different from each other.

12. The vehicle battery control device according to claim 11, further comprising:
an unavailability reason notification unit configured to notify an unavailability reason of the third battery operation mode determined to be unselectable by the selectability determination unit.

13. The vehicle battery control device according to claim 12,
wherein the unavailability reason notification unit is an unavailability reason display unit that displays the unavailability reason on the selection status display unit in an overlapping manner, and hides a part of the mode indicator displayed side by side on the selection status display unit.

14. The vehicle battery control device according to claim 11, further comprising:
a confirmation notification unit configured to notify an occupant of the vehicle of the first battery operation mode confirmed by the confirmation unit.

15. The vehicle battery control device according to claim 11, further comprising:
a determination unit configured to determine a selected state of the third battery operation mode after the third battery operation mode is selected by the input unit; and
a determination notification unit configured to notify an occupant of the vehicle of the third battery operation mode determined by the determination unit.

16. The vehicle battery control device according to claim 11, further comprising:
a constant display unit configured to constantly display the mode indicator corresponding to the first battery operation mode confirmed by the confirmation unit during a period of the first battery operation mode.

17. The vehicle battery control device according to claim 16,
wherein the constant display unit is provided at a position different from that of the selection status display unit.
